(19) United States
(12) Patent Application Publication
(10) Pub. No.: US 2017/0154616 A1
(43) Pub. Date: Jun. 1, 2017

(54) MIDI MALLET FOR TOUCH SCREEN DEVICES

(71) Applicant: ANTHONY GIANSANTE, KELOWNA (CA)

(72) Inventor: ANTHONY GIANSANTE, KELOWNA (CA)

(21) Appl. No.: 14/955,498

(22) Filed: Dec. 1, 2015

(51) Int. Cl. G10H 1/32; G10H 3/14; G10H 1/00

(52) U.S. Cl. CPC G10H 1/32; G10H 1/0066; G10H 3/146; G10H 2220/561; G10H 2220/401

(57) ABSTRACT

For music production, the velocity values with the purpose of creating dynamic percussion in cooperation with a value measuring surface (a touch screen tablet or touch screen phone) has the ability to simulate the tension of a percussion instrument thus tone values are correlated with X, Y values from a measuring surface and dynamics values are measured with velocity, all inclusive, wireless and cooperative with MIDI software.

### CROSS REFERENCE TO RELATED APPLICATIONS

### US Patent Documents

U.S. Ser. No. 06/665,781 15-1986 Yoshiki Hoshino

U.S. Pat. No. 5,009,146 A April 1991 Manabel Hajime

U.S. Pat. No. 5,471,008 A November 1995 Akihiro Fujita, Seiji Nakano, Katsushi Ishii

US-2011/0132181 A1 June 2011 Kockovic; Neven

US-2013/0152768 A1 June 2013 Rapp; John W.

US-2016/0203807 A1 July 2016 Hardi; Jason

US-2016/0247495 A1 August 2016 Dourmashkin; Steven

### STATEMENT REGARDING FEDERALLY SPONSORED RESEARCH OR DEVELOPMENT

NOT APPLICABLE

### NAMES OF THE PARTIES TO A JOINT RESEARCH AGREEMENT

NOT APPLICABLE

### INCORPORATION-BY-REFERENCE OF MATERIAL SUBMITTED ON A COMPACT DISC OR AS A TEXT FILE VIA THE OFFICE ELECTRONIC FILING SYSTEM

NOT APPLICABLE

### STATEMENT REGARDING PRIOR DISCLOSURE BY THE INVENTOR OR A JOINT INVENTOR

NOT APPLICABLE

### BACKGROUND OF INVENTION

(1) Field of Invention

The present invention relates to electronic music production for the purpose of creating a realistic simulation of percussion. Focused mainly on the dynamics, timbre, resonance, and tone of a percussion instrument, this invention focuses on giving the user control of these effects using wireless technology to send digital signals.

(2) Description of Related Art

Electronic drums have been used and are currently used in many aspects of music production.

They fall into two categories:

(A) Button FSR Midi Controllers

(B) Surface measuring electronic drums

In essence the fore mentioned invention combines the two ideas, allowing the feel of playing a drum as with (B) and the digital control as with (A).

Electronic drums that are button FSR midi controller (A) commonly referred to as drum machines operate like a keyboard, where force is measured with a force sensitive resistor and a MIDI signal is sent to the computer.

An example of a drum machine is in the following patent application:

(1) MIDI control apparatus, U.S. Pat. No. 5,471,008 A, Akihiro Fujita, Seiji Nakano, Katsushi Ishii

Electronic drums that are Surface Measuring Electronic Drums (B) have a special surface that allows the user to use a drum stick and play electronic drums as a normal instrument with sound recording pre-loaded onto the drum and triggered by striking the surface.

An example of a surface measuring electronic drum is in the following patent application:

(2) U.S. Ser. No. 06/665,781 15-1986 Yoshiki Hoshino

None of the above mentioned inventions are optimized for the use of touchscreen devices while category (A) does send velocity signals it fails to give the user the feel of playing a real percussive instrument, category (A) also does not optimize the use of touchscreen devices to mimic the tension of a drum. Category (B) does allow the user to mimic tension but it also does not optimize the use of a touch screen device or send MIDI signals to music production software. Neither of these categories are inclusive, wireless, force measuring devices that work in coordination with touch screen devices to simulate real percussion instruments.

### BRIEF SUMMARY OF INVENTION

The invention relates to electronic music production, where a small micro controller, a small Bluetooth chip, and a force sensitive resistor have been encased in a xylophone shaped mallet for the purpose of measuring the force when the mallet strikes a surface. The invention has been optimized for a touch screen device such as a tablet or touchscreen phones; when the fore mentioned touchscreen device is struck with the mallet a value based on where the touch screen device was struck is generated and a digital value from the velocity at which it was struck is generated.

### A BRIEF DESCRIPTION OF SEVERAL VIEWS OF THE DRAWING

FIG. 1a—Overview of the midi mallet with a spherical head and a cylindrical base

FIG. 1b—The inner composition consisting of a battery, a micro controller, and a force sensitive resistor

FIG. 2a—Circuitry of the micro controller to the power source

FIG. 2b—Circuitry of the micro controller to the Bluetooth Chip

FIG. 2c—Circuitry of the micro controller to the Force sensitive resistor

FIG. 3a—Linear shape diagram of the Force Sensitive Resistor

FIG. 3b—Spherical shape diagram of the Force Sensitive Resistor

FIG. 3c—Overview of a Force Sensitive Resistor

FIG. 4—Layered Diagram of the MIDI Mallet

FIG. 5a—Interior core of the Midi Mallet and components

FIG. 5b—Exterior conductive wrap

### THE MIDI MALLET

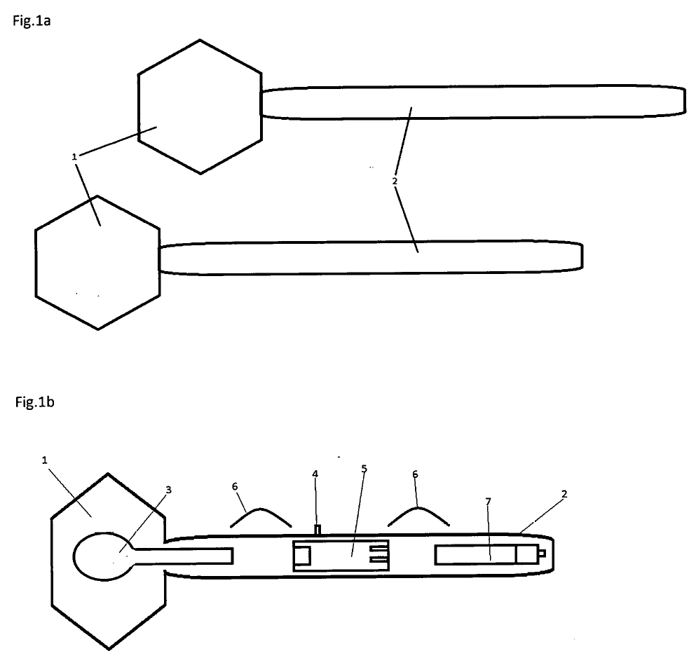

FIG. 1a is an overview of the invention FIG. 1a (1) is the head of the mallet which contains the force sensitive resistor and FIG. 1a (2) is the base which contains the circuitry and battery.

### The Circuitry

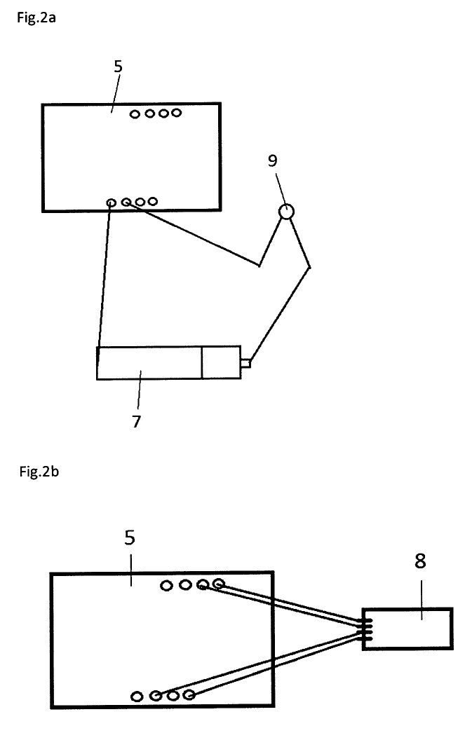

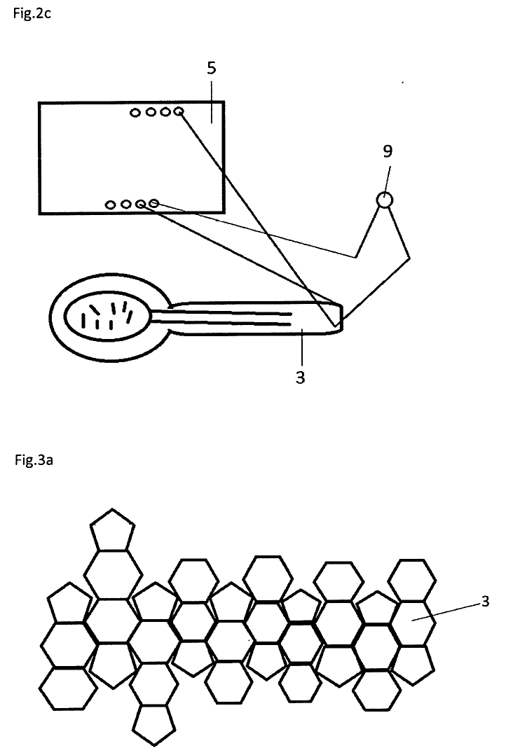

FIG. 1b show the inner workings of the MIDI mallet, FIG. 1b (7) show the AAAA battery, which is attached by a conductive wire FIG. 1b (6) which is attached to an Arduino Micro controller FIG. 1b (5) with Bluetooth FIG. 2b (8) which attaches to a Force Sensitive Resistor FIG. 1b (3).

### The Design

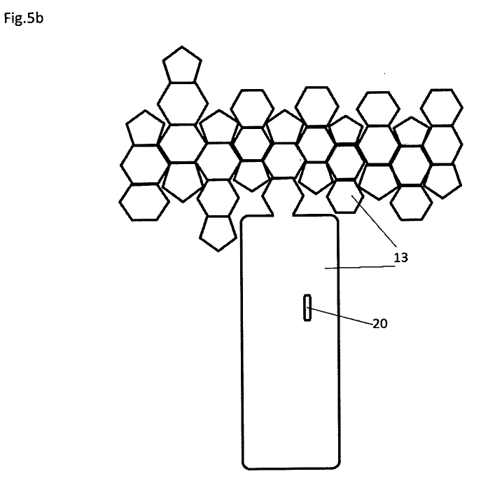

The core of the midi mallet (FIG. 5a) is composed to 2 separate pieces, the top mallet core FIG. 5b(15) which contains a male screw helix FIG. 5a(16) and the base piece FIG. 5b(14) which contains a female screw helix FIG. 5a(17) a hole for an on/off switch FIG. 5b(18) and a sliding battery door compartment FIG. 5a(19).

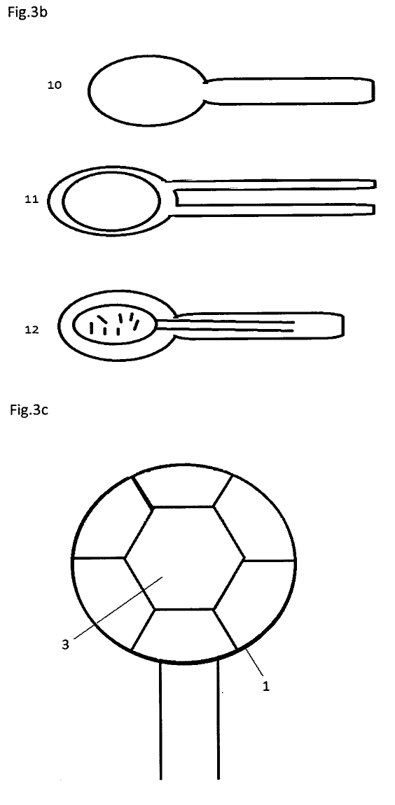

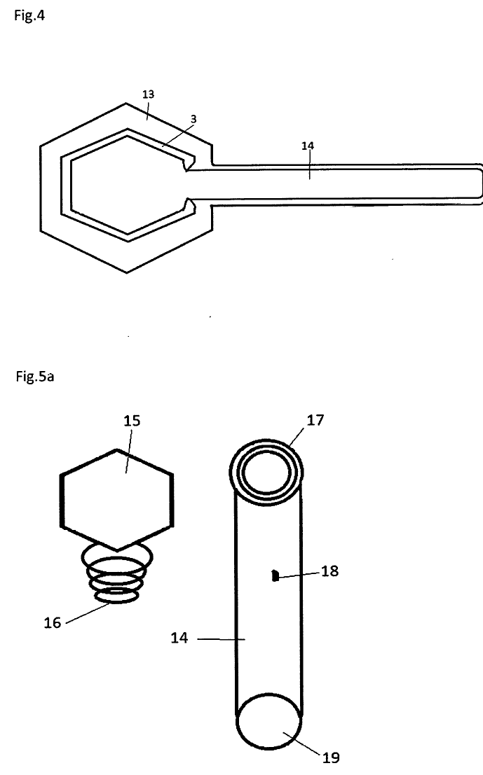

The mallet core FIG. 5a (14) is overlapped with a force sensitive resistor FIG. 4 (3), FIG. 3c, FIG. 3a and attached with a small amount of glue.

The outer conductive layer FIG. 4 (13), FIG. 5b (13) is a thin wrap made of an electrically conductive anti-static plastic that conducts electricity; alternatively it can also be a thin plastic wrap FIG. 5b (13) coated with conductive ink.

### DETAILED DESCRIPTION OF THE INVENTION

The present invention has been made to optimize the use of a touch screen device in professional music production. The current limitations of previous inventions are as follows: devices are large, bulky and must be connected through a USB port. Devices are unable to recreate an effective drum tension that otherwise creates the subtle tone of a drum and USB MIDI controllers play more like a piano than a drum.

An object of the present invention is that it is designed to work with a touch screen device which eliminates the use of a bulky box or surface measuring device and at the same time gives the user more control of the subtle dynamics of percussion.

Another object of the current invention is the wireless capabilities and that it is battery powered.

A further object is that it not only replicates the timber and tone of a real drum, it plays like a real drum in the sense that you are striking something with a mallet.

For the fore mentioned invention to adequately simulate a real drum it must work in cooperation with a touch screen device, and a specific software designed with preloaded musical recordings which are called samples that are triggered based on 3 dimensional grid.

The 3 dimensional grid consist of an X and Y coordinate which is based on where the mallet touches the touch screen device and a Z coordinate which is dictated based on the force in which the device is struck. All combined X, Y and Z allows for a larger amount of different samples to be triggered.
1) Head of Midi Mallet
2) Base of Midi Mallet
3) Force Sensitive Resistor
4) On/Off switch
5) Arduino Board
6) Connecting wire
7) Battery
8) Bluetooth chip
9) Resistors
10) Substrate with semi-conductor
11) Space adhesive
12) Substrate with electrodes
13) Exterior soft semi-conductor
14) Interior low density plastic
15) Mallet head interior
16) Screw attachment male head of mallet
17) Screw attachment female base of mallet
18) Hole for On/Off switch interior
19) Battery door
20) Hole for on off switch exterior

### SEQUENCE LISTING

NOT APPLICABLE

1) An electronic percussion instrument, in the shape of a mallet, that has a measurement scope in 3 dimensions, where the force measurement is inclusive to the mallet, which is made of a force sensitive resistor that covers the top mallet, where the fore mentioned force measurement is sent to a personal computer through a Bluetooth wireless signal and distributed to a software program through a MIDI value.

2.

3.

4) An electronic percussion instrument as fore mentioned in claim 1, is constructed using a micro controller at its inner core which is attached to a force sensitive resistor, which reads the signal, which is sent by a Bluetooth chip to personal computer, where the Bluetooth chip is attached to the fore mentioned micro controller, and the micro controller is powered by a battery.

5) An electronic percussion instrument as fore mentioned in claim 1, has an electrically conductive coating that covers the outer casing of the mallet, when struck against a touch screen device, registers coordinate data that works in cooperation with a software program to generate a MIDI signal.

6. Where the spherical force sensitive resistor from claim 1 can be any 3 dimension shape example: a cylinder, a triangle, a hexagon, pentagon . . . etc.

7. Where the Power Source from claim 4 can be battery powered, rechargeable, or by universal serial bus port.

8. Where the low density core in claim 2 can be plastic, wood, or metal.

9. Where the transmittance of information mentioned in claim 4 can be by Universal serial bus or Bluetooth transmittance.

10. Where the outer layer mentioned in claim 5 can be any material that that an electrical force can pass though.
